(19) United States
(12) Patent Application Publication
(10) Pub. No.: US 2015/0068937 A1
(43) Pub. Date: Mar. 12, 2015

(54) MILLING CUTTER BOX

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: YI-MIN JIANG, Shenzhen (CN); LI-FENG ZHAN, Shenzhen (CN); XIAO-TANG TANG, Shenzhen (CN)

(73) Assignee: HON HAI PRECISION INDUSTRY CO., LTD., New Taipei (TW)

(21) Appl. No.: 14/474,902

(22) Filed: Sep. 2, 2014

(30) Foreign Application Priority Data
Sep. 6, 2013 (CN) 2013104018758

(51) Int. Cl. B25H 3/00; B25H 3/02; B23Q 13/00

(52) U.S. Cl. CPC B25H 3/003; B23Q 13/00; B25H 3/02
USPC 206/349

(57) ABSTRACT

A milling cutter box includes a housing and a retaining member. The housing includes a box body and a box cover configured to couple with the box body. The retaining member is configured to couple with a milling cutter. The retaining member is rotatably coupled to the box body and received in the box body.

### FIELD

The subject matter herein generally relates to a milling cutter box configured to receive a milling cutter.

### BACKGROUND

When a milling cutter is not in use, a user can store the milling cutter in a box to prevent from damage. The user can open the box and remove the milling cutter from the box for use.

### BRIEF DESCRIPTION OF THE DRAWINGS

Implementations of the present technology will now be described, by way of example only, with reference to the attached figures.

FIG. 1 is an isometric view of an embodiment of a milling cutter box and a milling cutter received in the milling cutter box in a first state.

FIG. 2 is an isometric view of the milling cutter box and the milling cutter of FIG. 1 in a second state.

FIG. 3 is an exploded, isometric view of the milling cutter box of FIG. 1.

FIG. 4 is an isometric view of the milling cutter box of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure relates to a milling cutter box which can include a housing and a retaining member. The housing can include a box body and a box cover configured to couple with the box body. The retaining member can be configured to couple a milling cutter. The retaining member can be rotatably coupled to the box body and received in the box body.

The present disclosure is further in relation to a milling cutter box which can include a housing, a support member, and a retaining member. The housing can include a box body and a box cover configured to couple the box body. The support member can be received in the box body and detachably latched to the box body. The support member can include an engaging portion. The retaining member can be detachably pivoted to the support member and include a pivoting portion. The retaining member can define a receiving chamber and an opening communicating the receiving chamber with outer side of the retaining member. The pivoting portion can be pivoted to the engaging portion to enable the retaining member to be rotatable relative to the support member.

The present disclosure is further in relation to a milling cutter box which can include an elongate housing including a bottom, a support tray, and a retaining member. The support tray can be received in the housing and detachably attached to the bottom. The support tray can have a supporting portion at a distal end thereof. The supporting portion can define an opening. The retaining member can be detachably disposed on the supporting portion over the opening and rotatably coupled to the support tray. The retaining member can be configured for retaining a milling cutter. The retaining member can be rotatable relative to the support tray between a first position where the milling cutter is vertically oriented and a second position where the milling cutter is horizontally oriented and received in the housing. The opening can be configured for allowing an edge portion of the retaining member to pass therethrough when the retaining member moves between the first position and the second position.

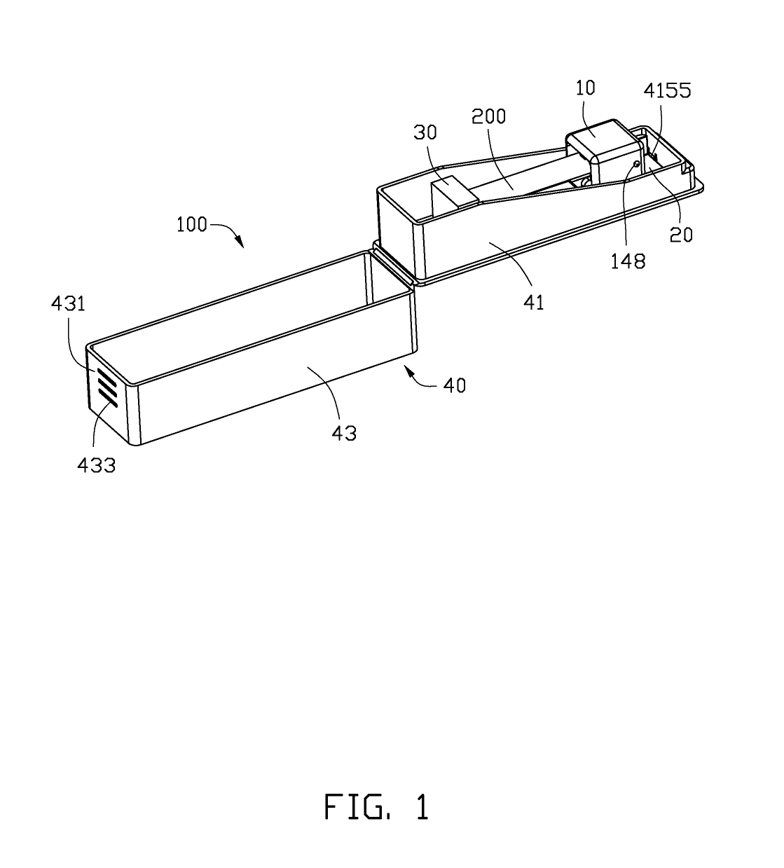

FIG. 1 illustrates an embodiment of a milling cutter box 100 configured to receive or couple a milling cutter 200. The milling cutter box 100 can include a retaining member 10, a support member 20, a protection portion 30, and a housing 40. The retaining member 10 can be rotatably coupled to the support member 20 and configured to couple the milling cutter 200. The protection member 30 can be fixed to the support member 20 and positioned opposite to the retaining member 10. The housing 40 can be an elongate housing including a bottom. The retaining member 10 and the protection member 30 can be received in the support member 20. The support member 20 can be received in the housing 40 and detachably attached to the bottom of the housing 40. When the milling cutter box 100 is closed, the support member 20, the retaining member 10, and the protection member 30 can be received in the housing 40.

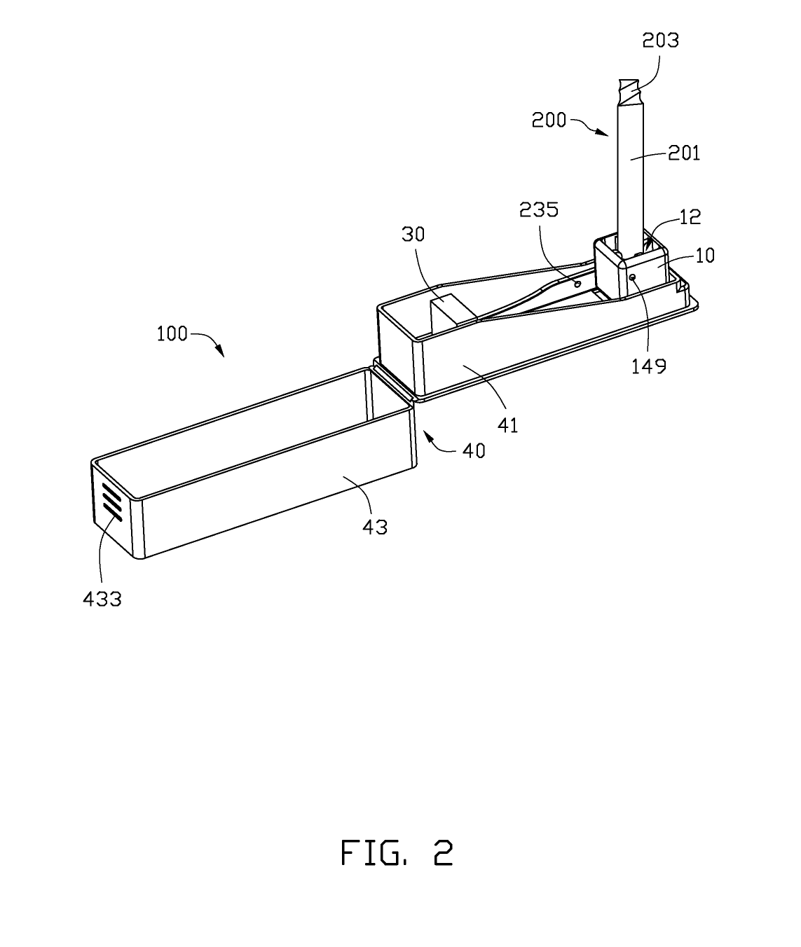

FIG. 2 illustrates that the milling cutter 200 can include a mounting portion 201 and a cutting portion 203 coupled to the mounting portion 201. The mounting portion 201 can be substantially cylindrical and include a smooth outer surface. The cutting portion 203 can be positioned at a distal end of the mounting portion 201 and coaxial with the mounting portion 203. The cutting portion 203 can include a cutting edge spiraling about a center axis of the cutting portion 203.

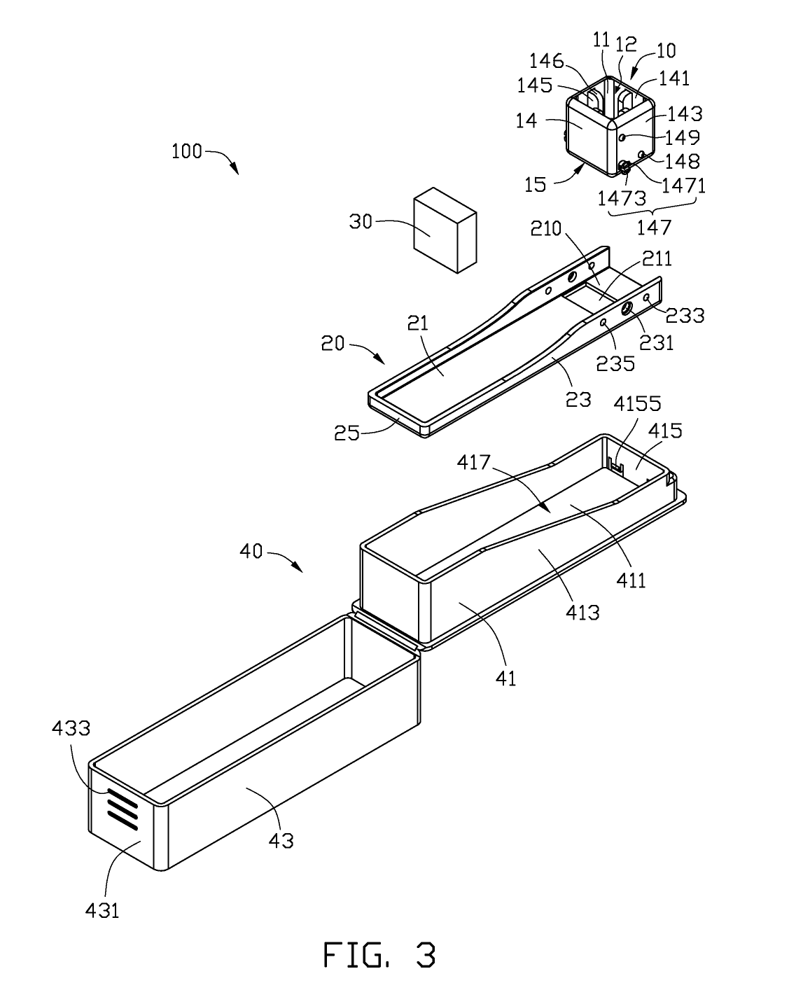

FIG. 3 illustrates that the retaining member 10 can be substantially hollow cuboid and define a receiving chamber 11 and an opening 12 communicating the receiving chamber 11 with outer side of the retaining member 10. The retaining member 10 can include a bottom wall 15 and four sidewalls 14 extending from edges of the bottom wall 15. Two of the sidewalls 14 can be parallel to each other and another two of the sidewalls 14 can be parallel to each other. The bottom wall 15 and the sidewalls 14 can define the receiving chamber 11. Each sidewall 14 can include an inner surface 141 and an outer surface 143 parallel to each other. A position portion 145 can protrude from each inner surface 141 and substantially perpendicular to the corresponding inner surface 141 and the bottom wall 15. The position portions 145 which respectively coupled to the parallel sidewalls 14 can be coplanar. The position portions 145 which respectively coupled to the adjacent sidewalls 14 can be perpendicular to each other. Each position portion 145 can include an arcuate guiding surface 146 adjacent to the opening 12.

A pivoting portion 147, a first positioning portion 148, and a second positioning portion 149 can be coupled to each outer surface 143 of two parallel sidewalls 14 of the four sidewalls 14. An imaginary connecting line of the pivoting portion 147 and the first positioning portion 148 can be substantially parallel to the bottom wall 15. An imaginary connecting line of the pivoting portion 147 and the second positioning portion 149 can be substantially perpendicular to the bottom wall 15. The first positioning portion 148 can be closer to the bottom wall 15 than the second positioning portion 149. The pivoting portion 147 can be a latching shaft and can be positioned diagonally relative to the corresponding sidewall 14. A diameter of a first end portion of the pivoting portion 147 away from the corresponding sidewall 14 can be larger than that of a second end portion of the pivoting portion 147 adjacent to the corresponding sidewall 14. Thus, a latching portion 1471 can be formed at the first end portion of the pivoting portion 147. The pivoting portion 147 can define a through groove 1473 along a center axis thereof. The through groove 1473 can extend through the latching portion 1471 towards a bottom of the pivoting portion 147. Thus, the pivoting portion 147 can be elastically deformed.

The support member 20 can include a bottom plate 21, two side plates 23 respectively extending from the bottom plate 21, and an end wall 25 extending from the bottom plate 21. The side plates 23 can be parallel to each other and perpendicular to the bottom plate 21. The end wall 25 can be perpendicular to the bottom plate 21 and the side plates 23. The bottom plate 21 can define an opening 211 adjacent to an end away from the end wall 25. The bottom plate 21 can include a supporting portion 210 at a distal end thereof and the opening 211 can be defined on the supporting portion 210. A first end portion of each side plate 23 adjacent to the opening 211 can be higher than a second end portion of each the side plate 23 away from the opening 211. Each side plate 23 can define an engaging portion 231 adjacent to the opening 211, a first latching portion 233, and a second latching portion 235. The first latching portion 233 and the second latching portion 235 can be respectively positioned at opposite sides of the engaging portion 231. In the illustrated embodiment, the support member 20 can be a support tray.

The engaging portion 231, the first latching portion 233, and the second latching portion 235 can be arranged in a straight line. A distance between the engaging portion 231 and the first latching portion 233 can be equal to a distance between the pivoting portion 147 and the first positioning portion 148. A distance between the engaging portion 231 and the second latching portion 235 can be equal to a distance between the pivoting portion 147 and the second positioning portion 149. A distance between the first latching portion 123 (or the second latching portion 149) to a top of the corresponding side plate 23 can be less than a distance of the first positioning portion 148 (or the second positioning portion 149) and the pivoting portion 147.

The bottom wall 15 of the retaining member 10 can be positioned on the bottom plate 21 and located between the side plates 23 (shown in FIG. 3). In the illustrated embodiment, the retaining member 10 can be detachably disposed on the supporting portion 210 over the opening 211 and rotatably coupled to the support member 20. An edge portion of the bottom wall 15 adjacent to the end wall 25 can be located above the opening 211. Thus, a connecting portion 17 of the bottom wall 15 and the corresponding side wall 14 can be positioned above the opening 211. The pivoting portion 147 can be received in the engaging portion 231 and the latching portion 1471 can be latched to the engaging portion 231. The first positioning portion 148 can be configured to latch the first latching portion 233 (shown in FIG. 3), to enable the opening 12 to be away from the support member 20. When the retaining member 10 is rotated 90 degrees around the pivoting portion 147, the second positioning portion 149 can be latched to the second latching portion 235 and the first positioning portion 148 can get out of the first latching portion 233 (shown in FIG. 3). Then, the opening 12 can face to the end wall 25.

In the illustrated embodiment, the first positioning portion 148 and the second positioning portion 149 are both posts, though other suitable positioning elements can be substituted. The engaging portion 231, the first latching portion 233, and the second latching portion 235 both can be holes. In at least one embodiment, one of the first positioning portion 148 and the first latching portion 233 can be a hole and another one can be a post. One of the second positioning portion 149 and the second latching portion 235 can be a hole and another one can be a post. One of the engaging portion 231 and the pivoting portion 147 can be a shaft and another one can be a hole.

The protection member 30 can be coupled to the bottom plate 21 and positioned adjacent to the end wall 25. When the second positioning portion 149 is latched with the second latching portion 235, a distance between the bottom wall 15 and the protection member 30 can be larger than a length of the milling cutter 200. The protection member 30 can be configured to protect the milling cutter 200. In at least one embodiment, the protection member 30 can be made of a flexible material, such as foam.

The housing 40 can include a box body 41 and a box cover 43 rotatably coupled to the box body 41. The box body 41 can include a bottom board 411, two parallel side boards 413, and two parallel end boards 415. The bottom board 411, the side boards 413, and the end boards 415 can define a receiving room 417, cooperatively. The receiving room 417 can be configured to receive the retaining member 10, the support member 20, and the protection member 30. The support member 20 can be received in the box body 41 and detachably coupled to the box body 41.

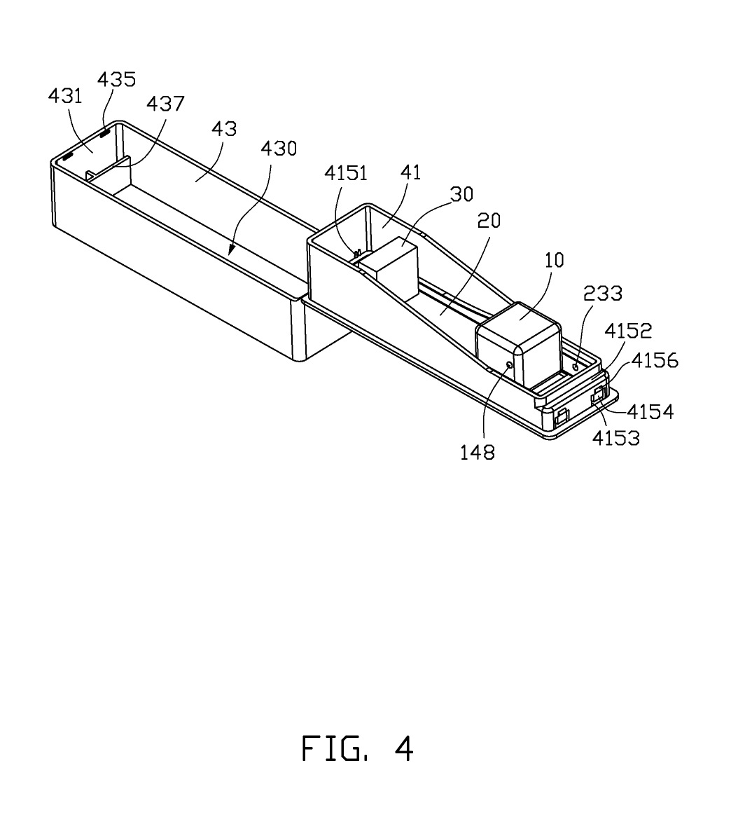

FIG. 4 illustrates that two first protrusions 4151 can protrude from one end board 415 adjacent to the box cover 43 and received in the box body 41. Another end board 415 can define a limiting groove 4152 and two through grooves 4153. The limiting groove 4152 can recess from an outer surface of the corresponding end board 415. The through grooves 4153 can pass through the outer surface and an inner surface of the corresponding end board 415. An elastic portion 4154 can be received in each through groove 4153 and coupled to the corresponding end board 415.

Two second protrusions 4155 (shown in FIG. 3) can protrude from the end board 415 away from the first protrusions 4151 and positioned at an inner surface of the elastic portions 4154. Two latching protrusions 4156 can protrude from the outer surface of the end board 415 which defining the through grooves 4153 thereon. Each latching protrusion 4155 can be positioned above the corresponding elastic portion 4154. The support member 20 can be detachably received in the box body 41 and positioned between the first protrusions 4151 and the second protrusions 4155. The first protrusions 4151 can be latched to a top surface of the end wall 25. The second protrusions 4155 can be latched to a top surface of the bottom plate 21.

The box cover 43 can define a receiving space 430 and rotatably coupled to an end of the bottom board 411 of the box body 41 away from the latching protrusions 4156. The box cover 43 can be configured to cover the box body 41, thereby receiving the retaining member 10, the protection member 30, and the support member 20 therein. The box cover 43 can include a latching wall 431 at an end away from a connection of the box cover 43 and the box body 41. An outer side surface of the latching wall 431 can define three anti-slip grooves 433 (shown in FIGS. 1-3). Two locking protrusions 435 can protrude from an inner side surface of the latching wall 431 and configured to couple the latching protrusions 4156. A limiting portion 437 can be fixed within the receiving space 430 and configured to couple limiting grooves 4152. In the illustrated embodiment, the limiting portion 437 can be ribs. In at least one embodiment, the first protrusions 4151, the second protrusions 4155, the through groves 4153, the elastic portion 4154, the latching protrusions 4156, and the locking protrusions 435 each can be designed to a desired number as needed, such as one or more than two.

In assembly, the support member 20 can be placed into the receiving room 417 of the box body 41. The first protrusions 4151 and the second protrusions 4155 can be respectively latched to the support member 20. The retaining member 10 can be mounted on the support member 20. The pivoting portion 147 can be pivoted with the engaging portion 231. The first positioning portion 148 can be latched to the first latching portion 233. The protection member 30 can be mounted in the support member 20 and positioned opposite to the retaining member 10.

In use, the mounting portion 201 of the milling cutter 200 can be inserted into the receiving chamber 11 via the opening 12 of the retaining member 10 and positioned in a first position by the positioning portions 145 (shown in FIG. 2). When the milling cutter 200 is in the first position, the milling cutter 200 can be vertically oriented. Then, the retaining member 10 can be forced to rotate about the pivoting portion 147 in 90 degrees (shown in FIG. 1). Thus, the bottom wall 15 can be perpendicular to the bottom plate 21 of the support member 20 and one of the side wall 14 can substantially contact the bottom plate 21. The opening 12 can face to the protection member 30. The first positioning portion 148 can release from the first latching portion 233 and the first portioning portion 148 can be positioned above the second positioning portion 149. The second positioning portion 149 can be latched to the second latching portion 235. The milling cutter 200 can be in a second position of substantially parallel to the bottom plate 21. When the milling cutter 200 is in the second position, the milling cutter 200 can be substantially horizontally oriented and received in the housing 40. The opening 211 can be configured for allowing an edge portion of the retaining member 10 to pass therethrough when the retaining member 10 moves between the first position and the second position. The box cover 43 can be rotated to cover the box body 41. The locking protrusions 435 can be latched to the latching protrusions 4156. The limiting portions 437 can be respectively received in the limiting grooves 4152 and resist against the corresponding end board 415. Thus, the milling cutter 200 can be received in the milling cutter box 100. When the box cover 43 is opened and the retaining member 10 is rotated, the milling cutter 200 can be convenient to be taken out.

In at least one embodiment, the support member 20 can be omitted and then the opening 211, the engaging portion 231, the first latching portion 233, and the second latching portion 235 can be directly formed on the cover box 41.

In at least one embodiment, the engaging portion 231, the first latching portion 233, and the second latching portion 235 can be only coupled to one side plate 23 of the support member 20. The engaging portion 231, the first latching portion 233, and the second latching portion 235 can be not in a straight line. The position portion 145 can be omitted and then the milling cutter 200 can be positioned by inner side surfaces of the retaining member 10.

In at least one embodiment, the first positioning portion 148, the second positioning portion 149, the first latching portion 233, and the second latching portion 235 both can be omitted. The pivoting portion 147 can be in a shape of a gear.

The embodiments shown and described above are only examples. Many details are often found in the art such as the other features of a milling cutter box. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A milling cutter box comprising:
a housing comprising:
a box body, and
a box cover configured to couple the box body;
a support member received in the box body and detachably latched to the box body, the support member having an engaging portion; and
a retaining member detachably pivoted to the support member and comprising a pivoting portion, the retaining member defining a receiving chamber and an opening communicating the receiving chamber with outer side of the retaining member, the pivoting portion pivoted to the engaging portion to enable the retaining member to be rotatable relative to the support member.

2. The milling cutter box of claim 1, wherein the support member further has a first latching portion and a second latching portion respectively positioned at opposite sides of the engaging portion, a first positioning portion and a second positioning portion are respectively coupled to the retaining member, the first positioning portion is configured to latch the first latching portion to enable the opening to be away from the support member, the second positioning portion is configured to latch the second latching portion to enable the opening to face an end wall of the support member.

3. The milling cutter box of claim 2, wherein the retaining member comprises a bottom wall and four sidewalls extending from edges of the bottom wall, the bottom wall and the sidewalls cooperatively define the receiving chamber, the pivoting portion, the first positioning portion, and the second positioning portion are coupled to the corresponding sidewall of the retaining member, the support member comprises two side plates; the engaging portion, the first latching portion, and the second latching portion are respectively formed on the corresponding side plate of the support member.

4. The milling cutter box of claim 3, wherein the engaging portion, the first latching portion, and the second latching portion are arranged in a substantially straight line, an imaginary connecting line of the pivoting portion and the first positioning portion is substantially parallel to the bottom wall of the retaining member, an imaginary connecting line of the pivoting portion and the second positioning portion is substantially perpendicular to the bottom wall of the retaining member.

5. The milling cutter box of claim 3, wherein the support member further comprises a bottom plate, the bottom plate defines an opening adjacent to an end away from the end wall, an edge portion of the bottom wall adjacent to the end wall is located above the opening.

6. The milling cutter box of claim 1, wherein a latching portion is formed at an end portion of the pivoting portion, the pivoting portion defines a through groove along a center axis thereof, the through groove extends through the latching portion towards a bottom of the pivoting portion, the engaging portion is a through hole, the latching portion is latched to the engaging portion.

7. The milling cutter box of claim 1, wherein the box body comprises two end boards, at least one first protrusion and at least one second protrusion respectively protrude from the end boards, the support member is received in the box body and positioned below the at least one first protrusion and the at least one second protrusion, the at least one first protrusion and the at least one second protrusion are respectively latched to the support member.

8. The milling cutter box of claim 7, wherein the box body is rotatably coupled to the box cover, the end board away from the at least one first protrusion defines a limiting groove and two through grooves, the through grooves are positioned below the limiting groove, an elastic portion is received in at least one of the two through grooves and coupled to the corresponding end board, the at least one second protrusion is positioned on the elastic portion, a limiting portion is fixed within the box cover and configured to couple the limiting groove.

9. The milling cutter box of claim 1, wherein two latching protrusions protrude from an outer side surface of the end board which defining the through grooves thereon, the box cover comprises a latching wall at an end away from a connection of the box cover and the box body, two locking protrusions protrude from an inner side surface of the latching wall and configured to couple the latching protrusions.

10. A milling cutter box comprising:
a housing comprising:
a box body, and
a box cover configured to couple the box body; and
a retaining member configured to couple with a milling cutter, the retaining member rotatably coupled to the box body and received in the box body.

11. The milling cutter box of claim 10 further comprising:
a support member received in the box body and detachably coupled to the box body, the retaining member being coupled to the box body via the support member.

12. The milling cutter box of claim 11, wherein the support member comprises a pivoting portion, the support member defines an engaging portion, the pivoting portion is pivoted to the engaging portion to enable the retaining member to be rotatable relative to the support member, the retaining member defines a receiving chamber and an opening communicating the receiving chamber with outer side of the retaining member.

13. The milling cutter box of claim 12, wherein one of the engaging portion and the pivoting portion is a shaft and another one is a hole.

14. The milling cutter box of claim 12, wherein the support member further defines a first latching portion and a second latching portion respectively positioned at opposite sides of the engaging portion, a first positioning portion and a second positioning portion are respectively coupled to the retaining member, a distance between the engaging portion and the first latching portion is equal to a distance between the pivoting portion and the first positioning portion, a distance between the engaging portion and the second latching portion is equal to a distance between the pivoting portion and the second positioning portion.

15. The milling cutter box of claim 14, wherein the retaining member comprises a bottom wall and four sidewalls extending from edges of the bottom wall, the bottom wall and the sidewalls cooperatively define the receiving chamber, the pivoting portion, the first positioning portion, and the second positioning portion are coupled to the corresponding sidewall of the retaining member, the support member comprises two side plates; the engaging portion, the first latching portion, and the second latching portion are respectively formed on the corresponding side plate of the support member, a distance between the first latching portion to a top of the corresponding side plate is less than a distance between the first positioning portion and the pivoting portion.

16. The milling cutter box of claim 15, wherein the engaging portion, the first latching portion, and the second latching portion are arranged in a substantially straight line, an imaginary connecting line of the pivoting portion and the first positioning portion is substantially parallel to the bottom wall of the retaining member, an imaginary connecting line of the pivoting portion and the second positioning portion is substantially perpendicular to the bottom wall of the retaining member.

17. The milling cutter box of claim 15, wherein a position portion protrudes from an inner surface of each sidewall, the position portion comprises an arcuate guiding surface adjacent to the opening.

18. The milling cutter box of claim 11 further comprising:
a protection member fixed within the support member.

19. The milling cutter box of claim 10, wherein the box body comprises two end boards, at least one first protrusion and at least one second protrusion respectively protrude from the end boards, the support member is positioned below the at least one first protrusion and the at least one second protrusion, the at least one first protrusion and the at least one second protrusion are respectively latched to the support member.

20. A milling cutter box comprising:
an elongate housing comprising a bottom;
a support tray received in the housing and detachably attached to the bottom, the support tray having a supporting portion at a distal end thereof, the supporting portion defining an opening; and
a retaining member detachably disposed on the supporting portion over the opening and rotatably coupled to the support tray, the retaining member configured for retaining a milling cutter, the retaining member being rotatable relative to the support tray between a first position where the milling cutter is vertically oriented and a second position where the milling cutter is horizontally oriented and received in the housing, the opening being configured for allowing an edge portion of the retaining member to pass therethrough when the retaining member moves between the first position and the second position.
